(19) United States
(12) Patent Application Publication
(10) Pub. No.: US 2026/0322934 A1
(43) Pub. Date: Oct. 15, 2026

(54) INSPECTION SYSTEM FOR INSPECTING IMAGE FORMED ON SHEET, READING DEVICE, AND INSPECTION DEVICE

(71) Applicant: CANON KABUSHIKI KAISHA, Tokyo (JP)

(72) Inventors: TAKESHI HONDA, Chiba (JP); KENSUKE SASAKI, Chiba (JP); KEISUKE KITAJIMA, Chiba (JP)

(21) Appl. No.: 19/636,787

(22) Filed: Apr. 1, 2026

(30) Foreign Application Priority Data
Apr. 10, 2025 (JP) 2025-065206

(51) Int. Cl. H04N 1/00; G06T 7/00

(52) U.S. Cl. CPC H04N 1/00798; G06T 7/001

(57) ABSTRACT

A reading device connectable to an inspection device that performs inspection of an image, includes: a plurality of reading units configured to read a sheet on which an image is formed in order to acquire image data; and a control unit configured to, after the reading device and the inspection device are connected by a cable in order to transmit the acquired image data to the inspection device, transmit identification information indicating each of the plurality of reading units to the inspection device via the cable.

### BACKGROUND

### Field of the Technology

The present disclosure relates to an inspection system that inspects an image formed on a sheet, and a reading device and an inspection device included in the inspection system.

### Description of the Related Art

US Patent Application Publication No. 2024/0397001 discloses an inspection system provided with an image forming apparatus, a reading device that reads an image formed on a sheet by the image forming apparatus, and an inspection device that inspects the image read by the reading device. According to US Patent Application Publication No. 2024/0397001, in order to be able to read both an image of a first surface of a conveyed sheet and an image of a second surface on an opposite side to the first surface, the reading device has two reading units, a first reading unit that reads the image of the first surface and a second reading unit that reads the image of the second surface.

The reading device and the inspection device are connected by a cable in order to transmit data of an image (image data) read by the reading device to the inspection device. There is room for further improvement in communication using a cable.

### SUMMARY

According to embodiments of the present disclosure, a reading device connectable to an inspection device that performs inspection of an image, includes: a plurality of reading units configured to read a sheet on which an image is formed in order to acquire image data; and a control unit configured to, after the reading device and the inspection device are connected by a cable in order to transmit the acquired image data to the inspection device, transmit identification information indicating each of the plurality of reading units to the inspection device via the cable.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing a configuration example of an image forming system according to an embodiment.

FIG. 2 is a diagram showing a configuration example of a controller according to an embodiment.

FIG. 3 is a diagram showing a configuration example of a reading control unit and an inspection device according to an embodiment.

FIG. 4 is a diagram showing initialization processing according to an embodiment.

FIG. 5 is a diagram showing an example of identification information.

FIG. 6 is a diagram showing inspection processing according to an embodiment.

FIG. 7 is a diagram showing an example of inspection result information.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Configuration of Image Forming System

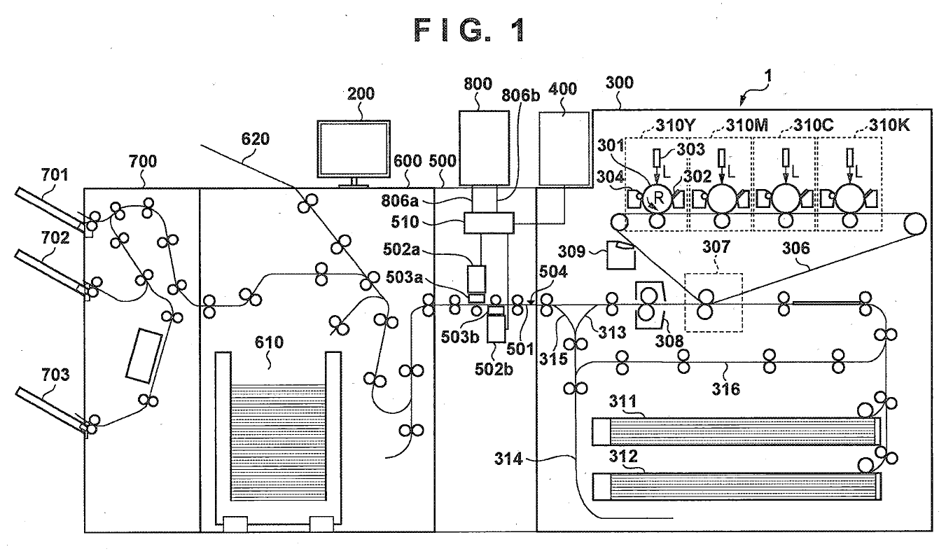

FIG. 1 shows a configuration example of an image forming system 1 according to the present embodiment. The image forming system 1 is provided with an operation unit 200, a printer 300 which is an image forming apparatus, a controller 400, a reading device 500, an inspection device 800, a stacker 600, and a finisher 700. Since the image forming system 1 has functions for forming an image on a sheet and inspecting the image formed on the sheet, it can also be referred to as an “inspection system”.

The operation unit 200 provides an input interface and an output interface of the image forming system 1. The input interface is, for example, an input key, a touch panel, or the like. The output interface is, for example, a display, a speaker, or the like. The operation unit 200 transmits an instruction or data input via the input interface to the controller 400. Also, the operation unit 200 performs output or display of information via the output interface according to an instruction from the controller 400.

The controller 400 controls operations of the printer 300, the reading device 500, the stacker 600, and the finisher 700 based on an instruction or data input from the operation unit 200, or an instruction or data acquired from an external apparatus via a network. For example, when a print job is received, the controller 400 instructs the printer 300 to perform image formation. Details of the controller 400 will be described later.

The printer 300 is an image forming apparatus that forms an image on a sheet. Image forming units 310Y, 310M, 310C, and 310K of the printer 300 respectively form images of yellow, magenta, cyan, and black and transfer them to an intermediate transfer member 306. Since the configurations of the image forming units 310Y, 310M, 310C, and 310K are similar, the configuration of the image forming unit 310Y will be described below.

A photosensitive member 301 is rotationally driven in an arrow R direction during image formation. A charger 302 charges a surface of the rotationally driven photosensitive member 301 to a uniform potential. An exposure unit 303 exposes the photosensitive member 301 based on data received from the controller 400 to form an electrostatic latent image on the photosensitive member 301. A developing unit 304 of the image forming unit 310Y contains a yellow developer (for example, toner). The developing unit 304 of the image forming unit 310Y forms a yellow image on the photosensitive member 301 by developing the electrostatic latent image formed on the photosensitive member 301 with the developer. The image formed on the photosensitive member 301 is transferred to the intermediate transfer member 306. Note that, by superimposing and transferring the images formed on the photosensitive members 301 of each of the image forming units 310Y, 310M, 310C, and 310K to the intermediate transfer member 306, colors different from yellow, magenta, cyan, and black can be reproduced.

The intermediate transfer member 306 is rotationally driven in a clockwise direction in the figure during image formation. The image transferred to the intermediate transfer member 306 is conveyed to a transfer unit 307 by rotation of the intermediate transfer member 306.

Sheets stored in cassettes 311 and 312 are conveyed to the transfer unit 307 by rollers provided along a conveyance path. The transfer unit 307 transfers the image of the intermediate transfer member 306 to the sheet. A cleaner 309 removes developer that was not transferred to the sheet and remained on the intermediate transfer member 306 from the intermediate transfer member 306. The sheet onto which the image has been transferred is conveyed to a fixing unit 308. The fixing unit 308 fixes the image on the sheet by heating and pressing the sheet.

In a case where images are formed on both surfaces of a sheet, the sheet for which fixing of an image onto one surface has been performed by the fixing unit 308 is conveyed to a conveyance path 314 via a conveyance path 313. Thereafter, the sheet is conveyed again to the transfer unit 307 via a duplex conveyance path 316, and image formation onto the other surface is performed. The sheet on which images are formed on both surfaces is conveyed to the reading device 500.

In a case where an image is formed only on one surface of a sheet and the sheet is discharged with an image forming surface facing downward, the sheet that has passed through the fixing unit 308 is conveyed to the conveyance path 314 via the conveyance path 313. Thereafter, the sheet is conveyed to the reading device 500 via a conveyance path 315. In a case where an image is formed only on one surface of a sheet and the sheet is discharged with the image forming surface facing upward, the sheet that has passed through the fixing unit 308 is conveyed to the reading device 500.

The sheet conveyed to the reading device 500 is conveyed to a downstream side by rollers provided along a conveyance path 501. A sheet detection sensor 504 detects the sheet. The reading device 500 has two reading units, a first reading unit 502a and a second reading unit 502b. In the following description, the two reading units of the first reading unit 502a and the second reading unit 502b are also collectively referred to as a reading unit 502. The first reading unit 502a reads an image of one surface of the sheet conveyed along the conveyance path 501 via a glass 503a. In the following description, the surface of the sheet from which the first reading unit 502a reads the image is referred to as a “first surface”. The second reading unit 502b reads an image of the other surface of the sheet conveyed along the conveyance path via a glass 503b. In the following description, the surface of the sheet from which the second reading unit 502b reads the image is referred to as a “second surface”.

The first reading unit 502a and the second reading unit 502b each include a light emitting unit and a light receiving unit. The light emitting unit is configured by, for example, a white light emitting diode (LED). The light receiving unit is configured by, for example, a complementary metal-oxide-semiconductor (CMOS) sensor with red (R), green (G), and blue (B) color filters. The light emitting unit irradiates light onto the sheet conveyed along the conveyance path 501 under control of a reading control unit 510. The light receiving unit receives reflected light from the sheet after decomposing the light into color components of three colors of RGB by the color filters, and acquires reading data as a light reception result (reading result).

The reading control unit 510 controls reading of an image by the first reading unit 502a and the second reading unit 502b under control of the controller 400. The reading control unit 510 determines a reading timing of an image by the first reading unit 502a and the second reading unit 502b based on a timing at which the sheet detection sensor 504 detected the sheet. The first reading unit 502a outputs reading data (hereinafter, first reading data) acquired by reading the image of the first surface to the reading control unit 510. The second reading unit 502b outputs reading data (hereinafter, second reading data) acquired by reading the image of the second surface to the reading control unit 510.

The reading control unit 510 is configured to be connectable to the inspection device 800 by two cables 806a and 806b. One of the two cables 806a and 806b is used for transmission of first image data based on the first reading data read by the first reading unit 502a to the inspection device 800. The other of the two cables 806a and 806b is used for transmission of second image data based on the second reading data read by the second reading unit 502b to the inspection device 800. The inspection device 800 inspects the quality of an image formed on the sheet based on the first image data and the second image data. Details of a connection configuration between the reading device 500 and the inspection device 800 will be described later. The sheet that has passed through the reading device 500 is conveyed to the stacker 600.

The stacker 600 is provided with a large-capacity tray 610 and a purge tray 620. The stacker 600 discharges the sheet to the large-capacity tray 610 or the purge tray 620, or conveys the sheet to the finisher 700, based on an instruction from the controller 400 and a quality inspection result by the inspection device 800.

The finisher 700 performs post-processing according to an instruction when post-processing such as stapling processing or bookbinding processing is instructed from the controller 400. The finisher 700 finally discharges the sheet to any of a tray 701, a tray 702, and a tray 703.

### Configuration of Controller 400

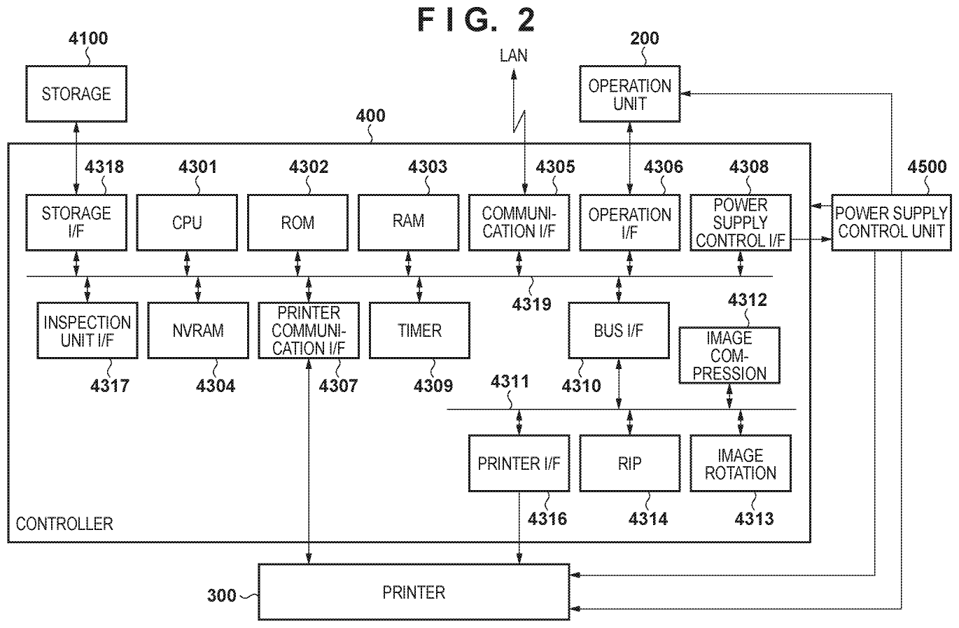

FIG. 2 shows a configuration example of the controller 400. According to FIG. 2, the controller 400 has two buses 4319 and 4311. Various units are connected to each of the bus 4319 and the bus 4311. A bus I/F 4310 is provided to connect the two buses 4319 and 4311.

As shown in FIG. 2, the controller 400 has various interface (I/F) units. The I/F units provide an interface for connecting the controller 400 to an external apparatus or an external unit. Specifically, a printer I/F 4316 connected to the bus 4311 and a printer communication I/F 4307 connected to the bus 4319 are both connected to the printer 300. The printer I/F 4316 is an interface used for transmission of data for image formation to the printer 300. The printer communication I/F 4307 is an interface used for transmission and reception of control information between a CPU 4301 and the printer 300.

An operation I/F 4306 is connected to the operation unit 200. An inspection I/F 4317 is connected to the inspection device 800. A storage I/F 4318 is connected to a storage 4100 not shown in FIG. 1. The storage 4100 is a large-capacity storage device such as, for example, an HDD (Hard Disk Drive) or an SSD (Solid State Drive). A power supply control I/F 4308 is connected to a power supply control unit 4500 not shown in FIG. 1. The power supply control unit 4500 supplies power to the printer 300, the controller 400, the reading device 500, the stacker 600, and the finisher 700. A communication I/F 4305 is connected to a network such as a local area network (LAN).

A central processing unit (CPU) 4301 is a processor and controls the image forming system 1 by executing a program. A read-only memory (ROM) 4302 stores a program or the like executed by the CPU 4301. A random access memory (RAM) 4303 provides a work area when the CPU 4301 executes processing. A non-volatile (NV) RAM 4304 stores various control parameters. A timer 4309 holds the current time and performs monitoring of elapsed time that has been set.

An image compression unit 4312 performs compression and decompression processing of data of an image formed by the printer 300. An image rotation unit 4313 performs rotation processing of an image. A raster image processor (RIP) 4314 expands page description language (PDL) code into a bitmap raster image.

As described above, the reading control unit 510 transmits image data acquired using each reading unit 502 to the inspection device 800 via different cables. This is because since the data amount of image data is large, if the image data acquired using each reading unit 502 is transmitted to the inspection device 800 via the same cable, the time required for transmission of image data becomes long.

In a case where a cable is provided for each reading unit 502, a constraint may arise that an interface of the reading device 500 for transmitting the first image data and an interface of the inspection device 800 for receiving the first image data must be connected by a cable. Similarly, a constraint may arise that an interface of the reading device 500 for transmitting the second image data and an interface of the inspection device 800 for receiving the second image data must be connected by a cable.

However, misconnection may occur in cable connection work. For example, a situation may occur in which the interface of the reading device 500 for transmitting the first image data and the interface of the inspection device 800 for receiving the second image data are connected by a cable. In this case, since the inspection device 800 performs inspection assuming that the received data is the second image data despite the data being the first image data, it becomes impossible to correctly perform inspection. Below, a configuration that relaxes constraints regarding connection of multiple cables in a case where multiple cables are used for transmission of image data from the reading device 500 to the inspection device 800 will be described.

### Reading Control Unit 510 and Inspection Device 800

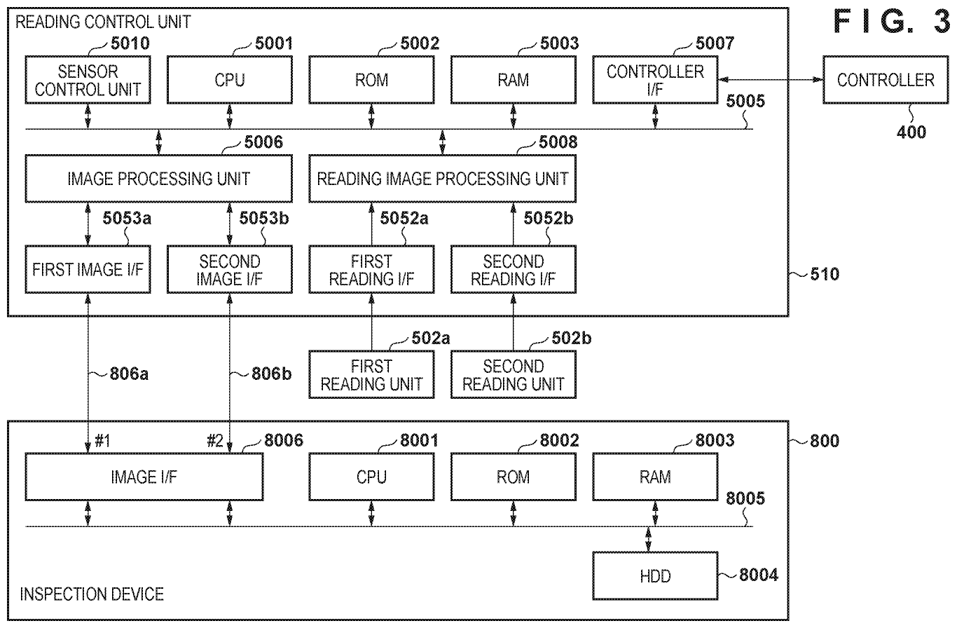

FIG. 3 shows configuration examples of the reading control unit 510 of the reading device 500 and the inspection device 800. The reading control unit 510 controls operations of the first reading unit 502a and the second reading unit 502b. A sensor control unit 5010, a CPU 5001, a ROM 5002, a RAM 5003, a controller I/F 5007, a reading image processing unit 5008, and an image processing unit 5006 are connected to a bus 5005 of the reading control unit 510. The reading image processing unit 5008 is connected to the first reading unit 502a via a first reading I/F 5052a, and is connected to the second reading unit 502b via a second reading I/F 5052b. The controller I/F 5007 is connected to the controller 400.

The CPU 5001 controls operations of the reading device 500 by executing a program stored in the ROM 5002. The RAM 5003 provides a work area when the CPU 5001 executes processing. The sensor control unit 5010 controls the sheet detection sensor 504.

The reading image processing unit 5008 acquires first reading data from the first reading unit 502a via the first reading I/F 5052a under control of the CPU 5001. Also, the reading image processing unit 5008 acquires second reading data from the second reading unit 502b via the second reading I/F 5052b under control of the CPU 5001. The reading image processing unit 5008 can perform image processing such as scaling processing and gamma correction processing on the first reading data and the second reading data under control of the CPU 5001. The reading image processing unit 5008 can store the first reading data and the second reading data after image processing into the RAM 5003 as first image data and second image data. Note that the reading image processing unit 5008 can also store the first reading data and the second reading data themselves into the RAM 5003 as the first image data and the second image data.

A first image I/F 5053a is an interface for transmitting the first image data acquired using the first reading unit 502a to the inspection device 800. In the present embodiment, a cable connected to the first image I/F 5053a is referred to as a cable 806a. A second image I/F 5053b is an interface for transmitting the second image data acquired using the second reading unit 502b to the inspection device 800. In the present embodiment, a cable connected to the second image I/F 5053b is referred to as a cable 806b.

The image processing unit 5006 performs processing such as transmitting the first image data to the inspection device 800 via the first image I/F 5053a and the cable 806a under control of the CPU 5001. The image processing unit 5006 performs processing such as transmitting the second image data to the inspection device 800 via the second image I/F 5053b and the cable 806b under control of the CPU 5001.

In this way, the inspection device 800 is configured to be connectable to the reading device 500 by two cables, the cable 806a and the cable 806b. Ends of the two cables 806a and 806b on an opposite side to ends connected to the reading control unit 510 are respectively connected to an image I/F 8006 of the inspection device 800. The image I/F 8006 is, for example, a frame grabber board. In this example, the image I/F 8006 has two interfaces, I/F #1 and I/F #2. In the example of FIG. 3, the cable 806a is connected to I/F #1 of the image I/F 8006, and the cable 806b is connected to I/F #2. However, as is clear from the following description, there is no problem even if the cable 806b is connected to I/F #1 of the image I/F 8006 and the cable 806a is connected to I/F #2.

The cable 806a and the cable 806b are, for example, coaxial cables. The cable 806a and the cable 806b can be cables with connectors, in which connectors are provided at both ends. Types of connectors provided in the first image I/F 5053a and the second image I/F 5053b can be the same. Also, types of connectors provided in I/F #1 and I/F #2 of the image I/F 8006 can be the same. In this case, there is no difference between the cable 806a and the cable 806b with connectors, and they can be the same cables with connectors.

Communication between the reading control unit 510 and the inspection device 800 via the cable 806a and the cable 806b, for example, transmission of the first image data and the second image data, can be performed according to a predetermined standard. As an example, the CoaXPress standard formulated by the Japan Industrial Imaging Association can be used for communication via the cable 806a and the cable 806b. In this case, the cable 806a and the cable 806b are also cables complying with the CoaXPress standard. The image processing unit 5006 controls data formats of the first image data and the second image data so as to comply with the standard to be used.

In the following, description will be given assuming that communication via the cable 806a and the cable 806b complies with the CoaXPress standard. However, communication via the cable 806a and the cable 806b may comply with a standard different from the CoaXPress standard. Furthermore, communication via the cable 806a and the cable 806b does not necessarily have to comply with a standard created by a standardization body or the like.

The image I/F 8006, a CPU 8001, a ROM 8002, a RAM 8003, and an HDD 8004 are connected to a bus 8005 of the inspection device 800. The CPU 8001 controls operations of the inspection device 800 by executing a program stored in the ROM 8002. The image I/F 8006 stores the first image data and the second image data from the reading device 500 into the RAM 8003. The image I/F 8006 can also store the first image data and the second image data into the HDD 8004.

First reference data and second reference data to be compared with each of the first image data and the second image data are stored in advance in the HDD 8004. The first reference data and the second reference data can be received from, for example, the controller 400. The controller 400 can transmit data for forming an image, which is a source of the first image data and the second image data, in the printer 300 to the inspection device 800 as the first reference data and the second reference data.

The CPU 8001 inspects the quality of the image formed on the first surface of the sheet by comparing the first image data with the first reference data. Also, the CPU 8001 inspects the quality of the image formed on the second surface of the sheet by comparing the second image data with the second reference data. The CPU 8001 notifies the reading control unit 510 of inspection results.

### Initialization Processing

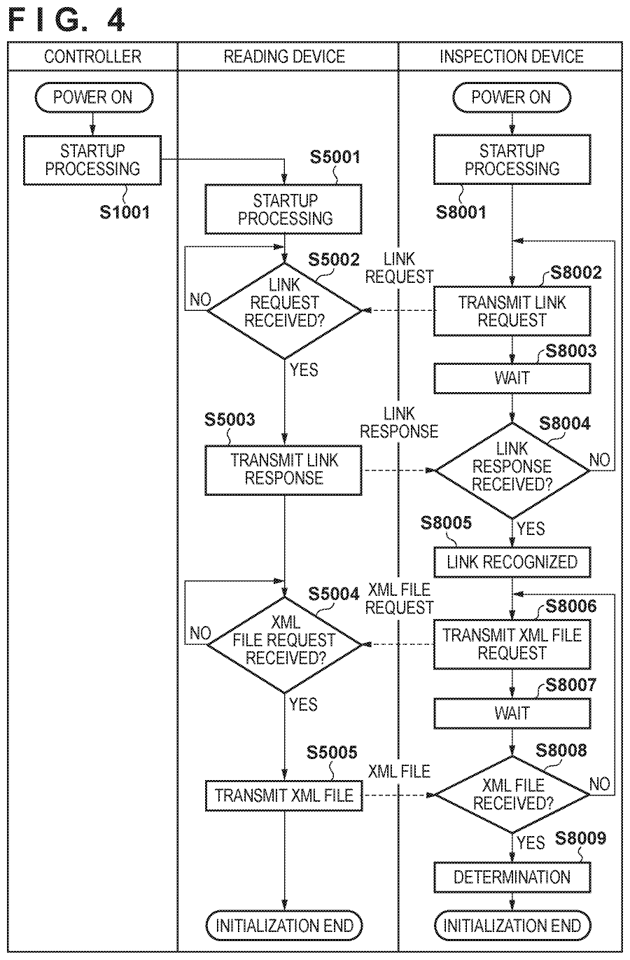

FIG. 4 shows processing at a time of startup of the image forming system 1. Note that, in FIG. 4, for simplification of the figure, only communication via the cable 806a is shown regarding communication between the reading device 500 and the inspection device 800. In reality, communication via the cable 806b is also performed between the reading device 500 and the inspection device 800 in addition to communication via the cable 806a. It is assumed that connection states of the cable 806a and the cable 806b are as shown in FIG. 3.

When power is turned on, the controller 400 starts startup processing in step S1001. In this startup processing, the controller 400 powers on the reading device 500. When the reading device 500 is powered on, the CPU 5001 of the reading device 500 executes startup processing in step S5001. After completion of the startup processing in step S5001, the CPU 5001 enters a state of waiting for reception of a link request message at each of the first image I/F 5053a and the second image I/F 5053b in step S5002. When a link request message from the inspection device 800 is received at, for example, the first image I/F 5053a connected to the cable 806a in step S5002, the CPU 5001 transmits a link response message to the inspection device 800 via the cable 806a in step S5003.

After transmitting the link response to the inspection device 800, the CPU 5001 enters a state of waiting for reception of an extensible markup language (XML) file request message at the first image I/F 5053a in step S5004. When the XML file request message is received from the inspection device 800 via the cable 806a in step S5004, the CPU 5001 transmits an XML file to the inspection device 800 via the cable 806a in step S5005, and ends the processing of FIG. 4.

The XML file transmitted by the CPU 5001 via the cable 806a includes identification information indicating a type of image data transmitted via the cable 806a. The type of image data can be distinguished by the reading unit 502 used for acquisition of the image data. That is, the XML file transmitted via the cable 806a includes identification information indicating the reading unit 502 used for acquisition of the image data transmitted via the cable 806a. In this example, the identification information included in the XML file transmitted via the cable 806a indicates that the first image data acquired using the first reading unit 502a is to be transmitted. Although not shown in FIG. 4, an XML file transmitted via the cable 806b includes identification information indicating that the second image data acquired using the second reading unit 502b is to be transmitted.

Meanwhile, when the power of the inspection device 800 is turned on, the CPU 8001 of the inspection device 800 starts startup processing in step S8001. After completion of the startup processing in step S8001, the CPU 8001 transmits a link request message from each I/F of the image I/F 8006 in step S8002. Subsequently, after waiting for a predetermined period in step S8003, the CPU 8001 determines in step S8004 whether a link response message has been received from the reading device 500 at each I/F of the image I/F 8006. If a link response message has not been received from the reading device 500, the CPU 8001 repeats processing from step S8002.

When a link response message is received from the reading device 500 at any I/F of the image I/F 8006 in step S8004, the CPU 8001 determines in step S8005 that a link has been established for the I/F that received the link response. That is, the CPU 8001 determines that the I/F that received the link response message has been connected to the reading device 500 by a cable. In this way, the CPU 8001 determines whether the reading device 500 and the inspection device 800 have been connected by a cable by determining whether messages can be exchanged with the reading device 500 via a cable. Here, it is assumed that the link response was received at I/F #1 of the image I/F 8006, that is, the first image I/F 5053a and I/F #1 of the image I/F 8006 were connected by the cable 806a.

In this case, the CPU 8001 transmits an XML file request message to the reading device 500 via the cable 806a in step S8006. Subsequently, after waiting for a predetermined period in step S8007, the CPU 8001 determines in step S8008 whether an XML file has been received from the reading device 500 via the cable 806a. If an XML file has not been received from the reading device 500, the CPU 8001 repeats processing from step S8006.

When an XML file is received via the cable 806a in step S8008, the CPU 8001 determines in step S8009 a type of image data to be received via the cable 806a, that is, at I/F #1 of the image I/F 8006, based on identification information included in the XML file. As described above, in this example, the XML file received via the cable 806a, that is, at I/F #1 of the image I/F 8006, includes identification information indicating that the first image data acquired using the first reading unit 502a is to be transmitted. Therefore, the CPU 8001 recognizes that the image data transmitted via the cable 806a is the first image data acquired using the first reading unit 502a based on the identification information included in the XML file. That is, based on the identification information of the XML file, the CPU 8001 determines which reading unit 502, between the first reading unit 502a and the second reading unit 502b, was used to acquire image data to be received at I/F #1 of the image I/F 8006.

In the example of FIG. 4, the inspection device 800 receives the first image data via the cable 806a, that is, at I/F #1 of the image I/F 8006. Therefore, the CPU 8001 recognizes that image data received at I/F #1 of the image I/F 8006 should be compared with the first reference data stored in the HDD 8004. Note that, if the cable 806a were connected to I/F #2 instead of I/F #1 of the image I/F 8006, the CPU 8001 would recognize that image data received at I/F #2 of the image I/F 8006 should be compared with the first reference data stored in the HDD 8004.

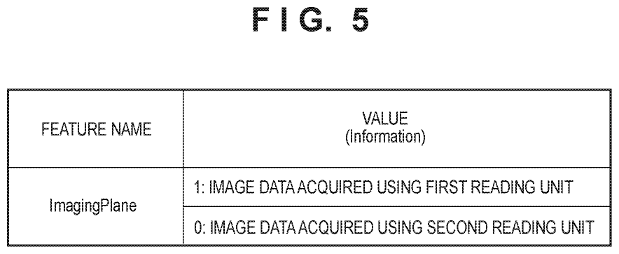

FIG. 5 shows an example of identification information included in the XML file transmitted by the CPU 5001 in step S5005. In this example, communication via the cable 806a and the cable 806b complies with the CoaXPress standard. Therefore, the XML file also complies with the CoaXPress standard. In the CoaXPress standard, Features that can be freely defined by a user are provided. One of the Features that can be freely defined by the user can be used for the identification information. As an example, a feature whose name is “ImagingPlane” can be used for the identification information.

The Access Mode of the ImagingPlane feature is Read Only. Other user-definable features whose access mode is defined as Read Only can be utilized for the identification information. Furthermore, any feature that can be freely defined by a user can be utilized for the identification information regardless of the access mode.

In FIG. 5, the value of the ImagingPlane feature being 1 indicates that the first image data acquired using the first reading unit 502a is to be transmitted via the cable used for transmission of the XML file. The value of the ImagingPlane feature being 0 indicates that the second image data acquired using the second reading unit 502b is to be transmitted via the cable used for transmission of the XML file.

### Inspection Processing

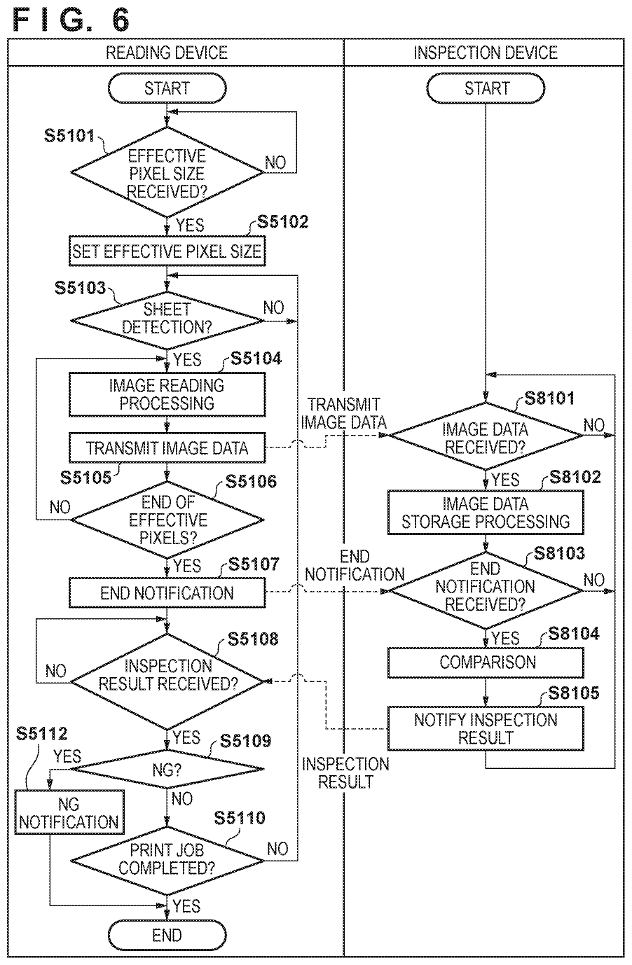

FIG. 6 shows processing performed in each of the reading device 500 and the inspection device 800 in a case where inspection processing is performed in the image forming system 1.

The CPU 5001 waits until effective pixel size information is received from the controller 400 in step S5101. When the effective pixel size information is received from the controller 400, the CPU 5001 sets the received effective pixel size information in step S5102. Subsequently, the CPU 5001 waits in step S5103 until the sheet detection sensor 504 detects a sheet. When the sheet detection sensor 504 detects a sheet, the CPU 5001 causes both or either one of the first reading unit 502a and the second reading unit 502b to read an image of the sheet in step S5104.

For example, in a case where an image is formed only on one surface of a sheet, if the image is on a side of the first reading unit 502a in the reading device 500, the CPU 5001 causes the first reading unit 502a to read the image. In a case where an image is formed only on one surface of a sheet, if the image is on a side of the second reading unit 502b in the reading device 500, the CPU 5001 causes the second reading unit 502b to read the image. In a case where images are formed on both surfaces of a sheet and both images formed on both surfaces are to be inspected, the CPU 5001 causes both the first reading unit 502a and the second reading unit 502b to read images. In a case where images are formed on both surfaces of a sheet but only an image formed on one surface is to be inspected, the CPU 5001 causes the reading unit 502, which can read the image to be inspected among the first reading unit 502a and the second reading unit 502b, to read the image.

The CPU 5001 starts transmission of image data to the inspection device 800 in step S5105. As described above, the first image data is transmitted via the cable 806a, and the second image data is transmitted via the cable 806b. The CPU 5001 repeats the processing of step S5104 and step S5105 until reading of effective pixels set in step S5102 is completed (step S5106). When reading of the effective pixels set in step S5102 is completed and transmission of image data is completed, the CPU 5001 transmits an end notification message to the inspection device 800 via the cable used for transmission of the image data for which transmission has been completed in step S5107.

When the end notification message is transmitted, the CPU 5001 waits until an inspection result is received from the inspection device 800 in step S5108. When the inspection result is received from the inspection device 800, the CPU 5001 determines in step S5109 whether the inspection result is “no problem” (OK) or “there is a problem” (NG). The inspection result of the first image data can be received via the cable 806a, and the inspection result of the second image data can be received via the cable 806b. If the inspection result is OK, the CPU 5001 determines whether a print job is completed in step S5110, and if it is not completed, repeats the processing from step S5103. On the other hand, if the print job is completed, the CPU 5001 ends the processing of FIG. 6. Also, if the inspection result is NG, the CPU 5001 notifies the controller 400 that the inspection result is NG in step S5112. In this case, the controller 400 notifies the CPU 5001 of a stop of the print job, and thus the CPU 5001 ends the processing of FIG. 6.

The CPU 8001 of the inspection device 800 waits until image data is received in step S8101. When the image data is received in step S8101, the CPU 8001 stores the received image data in the RAM 8003. The CPU 8001 repeats processing of step S8101 and step S8102 until an end notification message is received from the reading device 500. Upon receiving the end notification message from the reading device 500, the CPU 8001 determines whether an inspection result is OK or NG in step S8104 by, for example, comparing the image data with reference data stored in the HDD 8004. Note that, as described above, the first image data is compared with the first reference data, and the second image data is compared with the second reference data.

The CPU 8001 notifies the reading device 500 of the inspection result in step S8105. The CPU 8001 can transmit the inspection result of an image represented by the first image data, that is, an image formed on the first surface of the sheet, via the cable 806a. The CPU 8001 can transmit the inspection result of an image represented by the second image data, that is, an image formed on the second surface of the sheet, via the cable 806b.

However, the CPU 8001 can also be configured to collectively transmit the inspection results of two images formed on the first surface and the second surface of the same sheet via either one of the cable 806a and the cable 806b.

Similarly to the identification information, information indicating an inspection result (inspection result information) can be included in, for example, an XML file. Similarly to the identification information, a Feature that can be freely defined by a user can be used for the inspection result information. As an example, a feature whose name is “Result” can be used as the inspection result information.

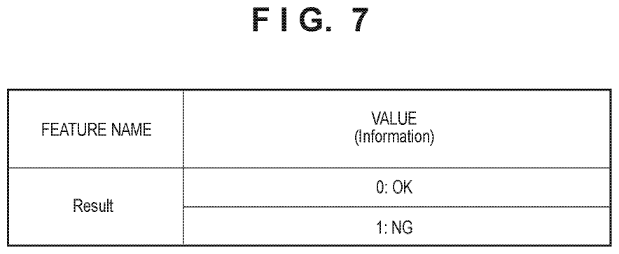

The Access Mode of the Result feature is Read/Write. Other user-definable features whose access mode is defined as Read/Write can be utilized for the inspection result information. Furthermore, any feature that can be freely defined by a user can be utilized for the inspection result information regardless of the access mode. In the example shown in FIG. 7, the value of the Result feature being 0 indicates that the inspection result is OK, and the value being 1 indicates that the inspection result is NG.

In the controller 400, when a notification that an inspection result is NG is received from the reading device 500 during execution of a print job, a sheet on which an image determined to be NG is formed can be discharged to a predetermined discharge destination such as, for example, the purge tray 620 of the stacker 600. Also, when the notification that the inspection result is NG is received from the reading device 500, the controller 400 performs processing necessary to stop the print job.

Note that, although the embodiment has been described taking the reading device 500 having two reading units 502 as an example, the present embodiment can also be applied to a reading device 500 having three or more reading units 502. For example, in order to speed up reading of image data, a configuration can be used in which a plurality of reading units 502 for reading an image of a first surface and/or reading units 502 for reading an image of a second surface are provided along the conveyance path 501. In such a case, three or more reading units 502 can be provided in the reading device 500. Even in such a case, when a cable to the inspection device 800 is connected, the reading device 500 transmits identification information for identifying the reading unit 502 used for acquisition of image data transmitted via the cable to the inspection device 800. With this configuration, the inspection device 800 can determine a type of image data received via the cable, and thus can determine reference data to be compared with the image data.

In the above embodiment, identification information indicating a type of image data transmitted via a cable and inspection result information indicating an inspection result of an image represented by the image data were transmitted via the cable used for transmission of the image data. However, the identification information and the inspection result information can also be configured to be transmitted and received via a dedicated control line connecting the reading device 500 and the inspection device 800. As an example, when the reading device 500 and the inspection device 800 are connected by a cable, the reading device 500 transmits a link identifier for identifying a link by the cable connection to the inspection device 800 via the cable. Then, when transmitting the identification information via the control line, the reading device 500 also transmits the link identifier. The inspection device 800 can determine via which cable and which type of image data is to be received according to the link identifier and the identification information. The same applies to the inspection result information.

Note that, instead of providing a dedicated control line connecting the reading device 500 and the inspection device 800, one cable among a plurality of cables that connect the reading device 500 and the inspection device 800 and are used for transmission of image data can also be used as the control line. The one cable used as the control line can be, for example, a cable that first connected the reading device 500 and the inspection device 800. In terms of the configuration of FIG. 3, when the cable 806a is first connected, the CPU 5001 transmits an XML file including identification information indicating that the first image data acquired using the first reading unit 502a is to be transmitted via the cable 806a via the cable 806a. Thereafter, when the cable 806b is connected, the CPU 5001 transmits an XML file including identification information indicating that the second image data acquired using the second reading unit 502b is to be transmitted via the cable 806b via the cable 806a.

The cable used as the control line may be a cable determined in advance, instead of the cable that first connected the reading device 500 and the inspection device 800. For example, it is assumed that the cable 806a is used as the control line. In this case, operation in a case where the cable 806a is first connected is similar to the above. On the other hand, in a case where the cable 806a is connected after the cable 806b, when the cable 806a is connected, the CPU 5001 transmits identification information indicating that the first image data is to be transmitted via the cable 806a and identification information indicating that the second image data is to be transmitted via the cable 806b via the cable 806a. Note that a link identifier for identifying a link by the cable connection is transmitted via the cable when the reading device 500 and the inspection device 800 are connected by the cable.

As described above, the reading device 500 transmits identification information indicating a type of image data transmitted via a cable to the inspection device 800. The type of image data can be distinguished by the reading unit 502 used for acquisition of the image data. With this configuration, the inspection device 800 can determine reference data to be compared with image data received at an interface to which the cable is connected, and perform inspection of the image data. Therefore, constraints regarding connection of multiple cables can be relaxed in a case where multiple cables are used for transmission of image data from the reading device 500 to the inspection device 800.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-065206, filed Apr. 10, 2025, which is hereby incorporated by reference herein in its entirety.

What is claimed is:

1. A reading device connectable to an inspection device that performs inspection of an image, the reading device comprising:
a plurality of reading units configured to read a sheet on which an image is formed in order to acquire image data; and
a control unit configured to, after the reading device and the inspection device are connected by a cable in order to transmit the acquired image data to the inspection device, transmit identification information indicating each of the plurality of reading units to the inspection device via the cable.

2. The reading device according to claim 1, wherein
the plurality of reading units comprises a first reading unit that reads a first image formed on a first surface of the sheet and a second reading unit that reads a second image formed on a second surface on an opposite side to the first surface of the sheet, and
the control unit is further configured to, in a case where the first reading unit is used for acquisition of the image data transmitted via a first cable and the second reading unit is used for acquisition of the image data transmitted via a second cable, transmit the identification information of each of the first reading unit and the second reading unit via the first cable or the second cable.

3. The reading device according to claim 1, wherein the control unit is further configured to transmit the identification information to the inspection device in response to receiving a request message from the inspection device via the cable.

4. The reading device according to claim 1, wherein
the plurality of reading units comprises a first reading unit that reads a first image formed on a first surface of the sheet and a second reading unit that reads a second image formed on a second surface on an opposite side to the first surface of the sheet, and
the control unit is further configured to, after the reading device and the inspection device are connected by a first cable, transmit the identification information indicating that the first reading unit is used for acquisition of the image data transmitted via the first cable to the inspection device, and after the reading device and the inspection device are connected by a second cable, transmit the identification information indicating that the second reading unit is used for acquisition of the image data transmitted via the second cable to the inspection device.

5. An inspection device connectable to a reading device having a plurality of reading units that read a sheet on which an image is formed in order to acquire image data, the inspection device comprising:
a control unit configured to, after the reading device and the inspection device are connected by a cable, receive identification information indicating each of the plurality of reading units used by the reading device for acquisition of image data transmitted via the cable via the cable, determine reference data to be compared with the image data received via the cable for inspection of the image based on the identification information, and notify the reading device of an inspection result of the image.

6. The inspection device according to claim 5, wherein the control unit is further configured to, after the reading device and the inspection device are connected by a first cable, receive via the first cable the identification information indicating that a first reading unit among the plurality of reading units, which reads a first image formed on a first surface of the sheet, is used by the reading device for acquisition of the image data transmitted via the first cable, and the identification information indicating that a second reading unit among the plurality of reading units, which reads a second image formed on a second surface on an opposite side to the first surface of the sheet, is used by the reading device for acquisition of the image data transmitted via a second cable.

7. The inspection device according to claim 5, wherein the control unit is further configured to receive the identification information from the reading device as a response to transmitting a request message to the reading device via the cable after the reading device and the inspection device are connected by the cable.

8. The inspection device according to claim 7, wherein the control unit is further configured to determine whether the reading device and the inspection device have been connected by the cable by determining whether a message can be exchanged with the reading device via the cable.

9. The inspection device according to claim 5, wherein the control unit is further configured to notify the reading device of the inspection result of the image via the cable.

10. The inspection device according to claim 5, wherein the control unit is further configured to, in a case where the identification information indicating that a first reading unit among the plurality of reading units, which reads a first image formed on a first surface of the sheet, is used by the reading device for acquisition of the image data transmitted via a first cable is received from the reading device after the reading device and the inspection device are connected by the first cable, and the identification information indicating that a second reading unit among the plurality of reading units, which reads a second image formed on a second surface on an opposite side to the first surface of the sheet, is used by the reading device for acquisition of the image data transmitted via a second cable is received from the reading device after the reading device and the inspection device are connected by the second cable, compare the image data received via the first cable with first reference data for inspection of the first image, and compare the image data received via the second cable with second reference data for inspection of the second image.

11. The inspection device according to claim 10, wherein the control unit is further configured to notify the reading device of an inspection result of the first image via the first cable, and notify the reading device of an inspection result of the second image via the second cable.

12. The inspection device according to claim 10, wherein the control unit is further configured to notify the reading device of both inspection results of the first image and the second image formed on the first surface and the second surface of the same sheet via any one of the first cable and the second cable.

13. An inspection system comprising:
a reading device; and
an inspection device,
wherein the reading device comprises:
a plurality of reading units configured to read a sheet on which an image is formed in order to acquire image data; and
a first control unit configured to, after the reading device and the inspection device are connected by a cable in order to transmit the acquired image data to the inspection device, transmit identification information indicating each of the plurality of reading units to the inspection device via the cable, and
the inspection device comprises:
a second control unit configured to, after the reading device and the inspection device are connected by the cable, receive the identification information via the cable, determine reference data to be compared with the image data received via the cable for inspection of the image based on the identification information, and notify the reading device of an inspection result of the image.

14. The inspection system according to claim 13, wherein communication between the first control unit and the second control unit via the cable complies with a CoaXPress standard.

15. The inspection system according to claim 14, wherein the identification information and the inspection result of the image are represented by an extensible markup language (XML) file.

16. The inspection system according to claim 14, wherein the identification information and the inspection result of the image are represented by features definable by a user in the CoaXPress standard.

17. The inspection system according to claim 16, wherein the identification information is represented by an ImagingPlane feature.

18. The inspection system according to claim 16, wherein the inspection result of the image is represented by a Result feature.

19. The inspection system according to claim 13, further comprising an image forming apparatus that forms the image on the sheet and conveys the sheet to the reading device.
